(19) United States
(12) Patent Application Publication
(10) Pub. No.: US 2010/0239953 A1
(43) Pub. Date: Sep. 23, 2010

(54) GAS DIFFUSION UNIT FOR A FUEL CELL

(75) Inventor: Lars Gerding, Kaiserslautern (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: CARL FREUDENBERG KG, Weinheim (DE)

(21) Appl. No.: 12/666,968

(22) PCT Filed: Jun. 5, 2008
(86) PCT No.: PCT/EP2008/004480

§ 371 Date: Jun. 9, 2010

(30) Foreign Application Priority Data
Jun. 29, 2007 (DE) 10 2007 030.343.4

(51) Int. Cl. H01M 8/04

(52) U.S. Cl. 429/512

(57) ABSTRACT

Gas diffusion unit (1) for a fuel cell (2), comprising at least dihedral gas diffusion layers (3, 4) which are provided with seals (5), wherein the seals (5) are fastened on a substrate (6), wherein the substrate (6) connects the gas diffusion layers (3, 4) to one another in an articulated fashion.

### TECHNOLOGICAL FIELD

The invention relates to a gas-diffusion unit for a fuel cell, comprising at least two gas-diffusion layers that have a planar construction and are provided with seals, wherein the seals are fixed on a substrate.

### BACKGROUND

Fuel cells consist of a series arrangement of individual cells. These form a so-called stack or cell stack in which additional components for cooling are often also integrated. Here, a stack can consist of up to 500 individual cells. A cell distinguishes itself through a layered construction, wherein a cell consists of an arrangement formed by two bipolar plates with a gas-distribution structure, two gas-diffusion layers, and a reaction layer in the form of a catalytic membrane. Two gas-diffusion layers respectively surround the reaction layer and form a membrane-electrode arrangement. For preventing leakage, the membrane-electrode arrangement or the bipolar plate is equipped with a seal. Leakage can lead to destruction or reduce the efficiency of the fuel cell. From US 2003/0082430 A1l , a gas-diffusion unit is known in which the seal is injection molded on the planar gas-diffusion layer. Here, for the assembly, it is difficult to align the gas-diffusion layers relative to each other so that the contact regions of the gas-diffusion layer and the reaction layer, as well as the gas-diffusion layer and the bipolar plate, will be sealed with no leakage.

### BRIEF SUMMARY

The invention provides a gas-diffusion unit for fuel cells that can be assembled with a sealed configuration in a simple and reliable manner.

The substrate connects the gas-diffusion layers to each other in an articulated manner. Here, in the ready-to-use state, a membrane is arranged between the gas-diffusion layers. Through the articulated connection by means of the substrate, a defined pivot axis is produced about which the gas-diffusion layers can pivot relative to each other. For producing a membrane-electrode unit, initially the membrane is arranged between the layers, then the gas-diffusion layers are pivoted one onto the other. Through the fixed pivoting movement, it is guaranteed that the two gas-diffusion layers and their seals are arranged in alignment with each other. Through the precise alignment of the seals, leakage is reliably prevented. The substrate could be inserted as a semi-finished part into a mold and then the sealing material could be injection molded around this part. Here, it is especially advantageous if the substrate is dimensionally stable, that is, it does not shrink in contrast to many sealing materials. Thus, warping of the gas-diffusion unit, having at least two gas-diffusion layers, due to shrinkage processes of the sealing material is effectively prevented. The substrate advantageously has a planar construction and has two recesses in which the gas-diffusion layers are arranged. The recesses can have the same dimensions as the gas-diffusion layers, or they can be shaped so that the gas-diffusion layers overlap the recesses. The dimensions of the recesses could also be larger than the dimensions of the gas-diffusion layers. The connection of the substrate and gas-diffusion layer is advantageously realized by a material fit by means of the seal arranged with homogeneous material and integrally on the substrate and gas-diffusion layer. In other constructions, the substrate could be connected with a positive fit connection or positive-fit and material-fit connection to the gas-diffusion layer. For this purpose, the substrate is arranged in recesses that are located in the seal.

The seals can be made from an elastic, polymer material. Elastomer materials are elastic, highly deformable, and easy to work. The seals can be made, for example, from silicone, FKM (fluoroelastomer), EPDM (ethylene propylene diene monomer), PIB (polyisobutylene), PU (polyurethane), BR (butadiene), or a mixture of these. By mixing, the advantageous properties of the individual materials can be combined selectively. Fluoroelastomers distinguish themselves through good temperature and chemical stability, which proves especially advantageous in the fuel-cell environment. In other constructions, thermoplastic materials, for example, thermoplastic elastomers (TPE) are also conceivable as sealing material. The latter have, in particular, the advantage that they can be worked in short cycle times like thermoplastic materials.

The substrate can be constructed as a plastic film. Plastic films can be produced easily and economically. Here, plastic qualities are available that are resistant relative to media and temperatures prevailing in fuel cells. The production of the substrate is realized by means of planar plastic layers out of which the substrates are stamped. As the material for the substrate, for example, polyethylene naphthalate (PEN) and polyetherimide (PEI) are suitable. These materials are chemically resistant and can be loaded thermally.

Conceivable production methods for attaching a seal to the gas-diffusion layer are injection molding, pressing, adhesion, and casting. Here, pressing is a production method that is especially favorable due to low mold and machine costs and allows the seals to be produced with the tight tolerances that are typical for fuel cells with high dimensional accuracy. Adhesion allows a modular-like production in which different constructions of seals can be combined with different constructions of gas-diffusion layers and is especially suitable for smaller piece numbers due to its flexibility. The seals could be molded onto the gas-diffusion layer. Injection molding is a production method that is compatible with mass production. Through the molding on the gas-diffusion layers, a seal is completely surrounded by the reaction layer arranged between the gas-diffusion layers, so that leakage is avoided. In the case of injection molding, it is advantageous if the sealing material that is molded onto the gas-diffusion layer penetrates into the gas-diffusion layer. The penetration takes place especially for gas-diffusion layers that are formed from a non-woven material. In this way, the sealing effect and also the handling are improved even more.

The seals can have at least one sealing bead that is at least partially circular. The sealing bead can be formed, in particular, with a U or V shape. A sealing bead improves the sealing effect and simplifies the mounting of the membrane-electrode unit. For mounting, the gas-diffusion layers connected to each other are pressed to each other with the membrane arranged in-between, for example, by screw connections between bipolar plates. Due to the small contact face of the sealing bead, the contact force is initially small, but rises steadily with increasing compression. After complete compression of the sealing bead, the adjacent, planar sealing area is led into engagement and the contact force increases disproportionately, which can be an indicator for a correct contact force and, thus, sealing force. An overpressure of the seal by a contact force that is too great is therefore avoided. In addition, the sealing bead equalizes tolerances and unevenness in the surface to be sealed.

The seals can be fixed with a material-fit connection on the substrate. The seal is advantageously deposited by means of injection molding on the substrate and the gas-diffusion layer. Here, a material-fit connection is produced after solidification of the sealing material. In the substrate, there can be recesses through which the sealing material can flow. Here, a positive-fit connection and an improved bonding of the seal on the substrate are produced.

The substrate can be constructed such that a film hinge forms between the gas-diffusion layers. For this purpose, the substrate is constructed so that it can hold two gas-diffusion layers. These are connected rigidly to the substrate by the sealing material. After placing the membrane, the gas-diffusion layers are to be pivoted one on the other by means of the substrate. A film hinge formed by the substrate is very robust, has improved mechanical properties, and cannot tear in contrast to those made from elastomer materials. Large dimensions are also possible.

Closure elements could be arranged on the gas-diffusion layers. The closure elements are here located advantageously in the edge region of the seal and are integrated in the seal and constructed with the same material as this seal. These closure elements of the gas-diffusion layers are advantageously constructed so that they are congruent to each other. Thus, after placement of the membrane and the pivoting, the gas-diffusion layers can be connected to each other. Therefore, the membrane is disposed between the gas-diffusion layers, simplifying the handling and mounting. The closure elements are advantageously constructed so that a detachable connection is produced. If the closure element is integrated in the seal, then it is especially easy to operate due to the elastomer material of the seal.

The closure elements can be formed by positive-fit elements. Such closure elements are, for example, dovetail-joint grooves in one gas-diffusion layer and corresponding projections in the other gas-diffusion layer. The groove and the projection are advantageously formed in the edge region of the seal. In general, a closure element has an undercut in which a fitting counterpart of the other closure element engages. Positive-fit elements are usually connections that are easy to detach and easy to join, especially if they are located in elastomer materials.

The closure elements can be integral components of the seals. Therefore, they can be produced in an especially simple way and are also easy to operate due to the elastomer materials of the seals. Because the seals can be advantageously produced through injection molding, the closure elements can also be provided easily and economically in the mold.

Embodiments of a gas-diffusion unit according to the invention are explained in more detail below with reference to the figures, shown in each case schematically.

### BRIEF DESCRIPTION OF THE DRAWINGS

FIG. 1 is a top view of a gas-diffusion unit,

FIG. 2 is a side view of the gas-diffusion unit of FIG. 1,

FIG. 3a is a side view of a gas-diffusion unit with a closure element,

FIG. 3b is a side view of the gas-diffusion unit according to FIG. 3a folded together with a sandwiched membrane, and

FIG. 4 is a fuel cell with gas-diffusion units according to the invention.

### DETAILED DESCRIPTION

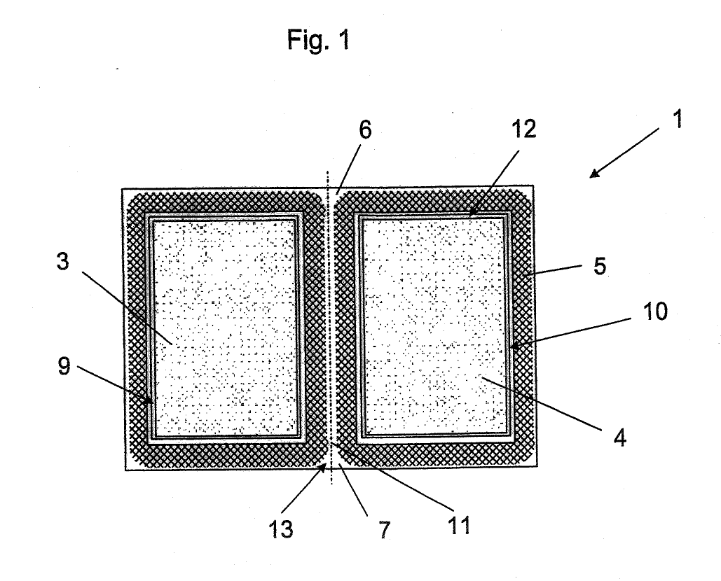

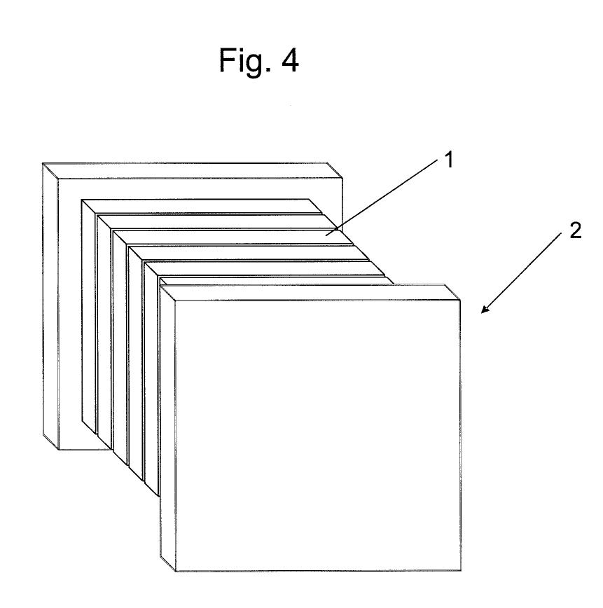

In a top view, FIG. 1 shows a gas-diffusion unit 1 for a fuel cell 2 (shown in FIG. 4), comprising two planar gas-diffusion layers 3, 4 that are arranged adjacent to each other. The gas-diffusion layers 3, 4 are arranged in recesses 9, 10 of a substrate 6. The substrate 6 has a planar construction and is made from plastic, for example, from PEN or PEI. The gas-diffusion layers 3, 4 are made from a carbonized non-woven material, wherein seals 5 are arranged on the substrate 6 and also at the edges of the gas-diffusion layers 3, 4. In one embodiment, the seals 5 are made from a composition with silicone and were fixed by means of injection molding on the substrate 6 and on the gas-diffusion layers 3, 4, wherein the sealing material has penetrated into the pores of the non-woven material and connects to the substrate with a material fit. In other embodiments, the seal 5 can be made from silicone, thermoplastic elastomers, EPDM (ethylene-propylene-diene monomer), PIB (polyisobutylene), PU (polyurethane), BR (butadiene), or a combination of any of these materials. The gas-diffusion layers 3, 4 are connected to each other in an articulated way by the substrate 6.

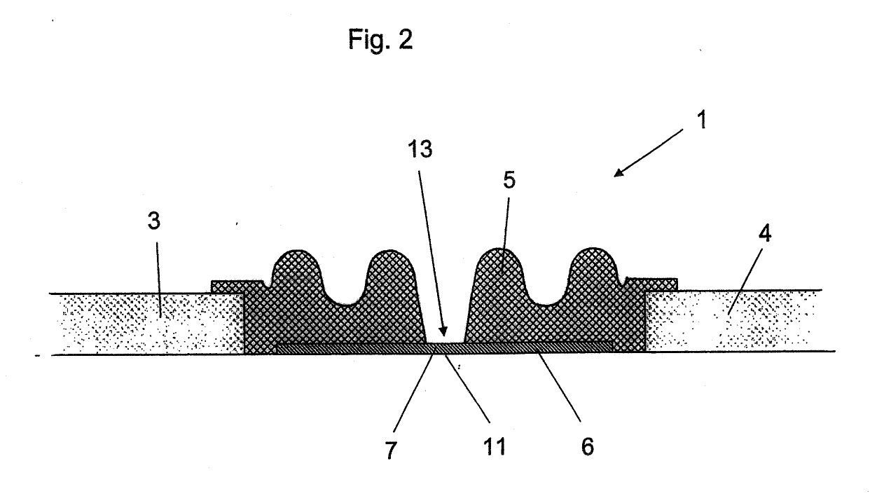

FIG. 2 shows the gas-diffusion unit 1 according to FIG. 1 in a side view. Along the center line 11 of the substrate 6, the seal 5 has a recess 13, so that a film hinge 7 forms here, by means of which both sides of the substrate 6 can be pivoted with the associated gas-diffusion layers 3, 4. The seals 5 are profiled and can have U- or V-shaped projections.

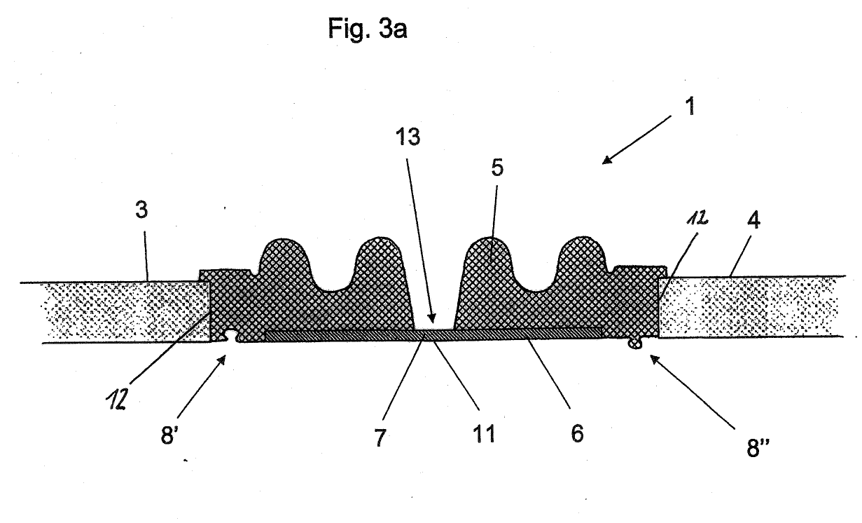

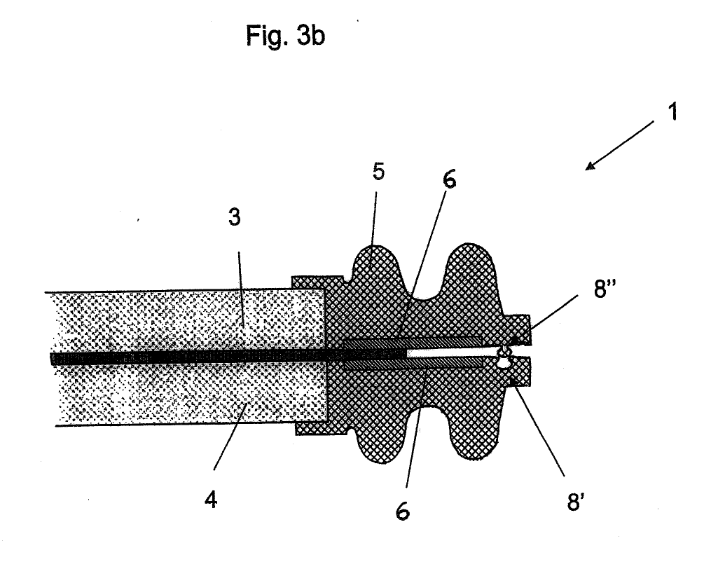

FIGS. 3a and 3b show a gas-diffusion unit 1 according to FIG. 2. In these constructions, the seals 5 are likewise profiled, and each of these seals has a closure element 8 as an integral component at the boundary edges 12 allocated to the gas-diffusion layers 3, 4, wherein the closure elements 8 of each gas-diffusion layer 3, 4 are formed congruent to each other and allow a positive-fit connection of the two gas-diffusion layers 3, 4. For this purpose, a closure element 8′ has a circular recess, and the other closure element 8″ has a circular projection. FIG. 3b shows the gas-diffusion unit 1 in which the gas-diffusion layers 3, 4 were pivoted about the substrate 6 and, in this way, arranged one on the other. The gas-diffusion layers are locked to each other by the closure elements 8. Due to the closure elements 8, a membrane has a captive arrangement between the gas-diffusion layers 3, 4.

FIG. 4 shows a fuel cell 2 for mobile applications. The gas-diffusion units 1 that are arranged in the fuel cell 2 can have a thickness of less than one millimeter.

1-7. (canceled)

8. A gas-diffusion unit for a fuel cell, comprising: a plurality of planar gas-diffusion layers having seals, the seals being fixed to a substrate, the substrate connecting at least two of the gas-diffusion layers to each other in an articulated manner.

9. The gas-diffusion unit of claim 8, wherein the substrate is a plastic film.

10. The gas-diffusion unit of claim 8, wherein the seals are integral with the substrate.

11. The gas-diffusion unit of claim 8, wherein the substrate forms a hinge between gas-diffusion layers.

12. The gas-diffusion unit of claim 8, further comprising closure elements disposed on the gas-diffusion layers.

13. The gas-diffusion unit of claim 12, wherein the closure elements are positive-fit elements.

14. The gas-diffusion unit of claim 13, wherein the closure elements are integral with the seals.
